(19) United States
(12) Patent Application Publication
(10) Pub. No.: US 2009/0051984 A1
(43) Pub. Date: Feb. 26, 2009

(54) IMAGE SENSOR HAVING CHECKERBOARD PATTERN

(76) Inventors: Michele O'Brien, Rochester, NY (US); John T. Compton, LeRoy, NY (US); Christopher Parks, Rochester, NY (US); Efrain O. Morales, Rochester, NY (US)

Correspondence Address: Frank Pincelli;Patent Legal Staff, Eastman Kodak Company, 343 State Street, Rochester, NY, 14650-2201, US

(21) Appl. No.: 11/843,846

(22) Filed: Aug. 23, 2007

(51) Int. Cl. H04N 1/46

(52) U.S. Cl. 358/514

(57) ABSTRACT

An image sensor for capturing a color image, comprising a two-dimensional array of pixels having a plurality of minimal repeating units wherein each repeating unit is composed of eight pixels having four panchromatic pixels, two pixels having the same color response, and two pixels having different color responses that are different than the pixels having the same color response, with the minimal repeating units tiled to cause each row or each column of the image sensor to have color pixels of a single color or to cause each row and each column to have color pixels of only two colors.

### CROSS REFERENCE TO RELATED APPLICATIONS

The present application is related to U.S. Ser. No. 11/191,538, filed Jul. 28, 2005, of John F. Hamilton Jr. and John T. Compton, entitled “PROCESSING COLOR AND PANCHROMATIC PIXELS”;

U.S. Ser. No. 11/191,729, filed Jul. 28, 2005, of John T. Compton and John F. Hamilton, Jr., entitled “IMAGE SENSOR WITH IMPROVED LIGHT SENSITIVITY”;

U.S. Ser. No. 11/210,234, filed Aug. 23, 2005, of John T. Compton and John F. Hamilton, Jr., entitled “CAPTURING IMAGES UNDER VARYING LIGHTING CONDITIONS”;

U.S. Ser. No. 11/341,206, filed Jan. 27, 2006 of James E. Adams, Jr., et al., entitled “INTERPOLATION OF PANCHROMATIC AND COLOR PIXELS”; and

U.S. Ser. No. 11/341,210, filed Jan. 27, 2006 of Hideo Nakamura, et al., entitled IMAGE SENSOR WITH IMPROVED LIGHT SENSITIVITY.

### FIELD OF THE INVENTION

This invention relates to a two-dimensional color image sensor with panchromatic pixels with improved light sensitivity.

### BACKGROUND OF THE INVENTION

An electronic imaging system depends on an electronic image sensor to create an electronic representation of a visual image. Examples of such electronic image sensors include charge coupled device (CCD) image sensors and active pixel sensor (APS) devices (APS devices are often referred to as CMOS sensors because of the ability to fabricate them in a Complementary Metal Oxide Semiconductor process). Typically, these images sensors include a number of light sensitive pixels, often arranged in a regular pattern of rows and columns. For capturing color images, a pattern of filters is typically fabricated on the pattern of pixels, with different filter materials being used to make individual pixels sensitive to only a portion of the visible light spectrum. The color filters necessarily reduce the amount of light reaching each pixel, and thereby reduce the light sensitivity of each pixel. A need persists for improving the light sensitivity, or photographic speed, of electronic color image sensors to permit images to be captured at lower light levels or to allow images at higher light levels to be captured with shorter exposure times.

Image sensors are either linear or two-dimensional. Generally, these sensors have two different types of applications. The two-dimensional sensors are typically suitable for image capture devices such as digital cameras, cell phones and other applications. Linear sensors are often used for scanning documents. In either case, when color filters are employed the image sensors have reduced sensitivity.

A linear image sensor, the KLI-4104 manufactured by Eastman Kodak Company, includes four linear, single pixel wide arrays of pixels, with color filters applied to three of the arrays to make each array sensitive to either red, green, or blue in its entirety, and with no color filter array applied to the fourth array; furthermore, the three color arrays have larger pixels to compensate for the reduction in light sensitivity due to the color filters, and the fourth array has smaller pixels to capture a high resolution luminance image. When an image is captured using this image sensor, the image is represented as a high resolution, high photographic sensitivity luminance image along with three lower resolution images with roughly the same photographic sensitivity and with each of the three images corresponding to either red, green, or blue light from the image; hence, each point in the electronic image includes a luminance value, a red value, a green value, and a blue value. However, since this is a linear image sensor, it requires relative mechanical motion between the image sensor and the image in order to scan the image across the four linear arrays of pixels. This limits the speed with which the image is scanned and precludes the use of this sensor in a handheld camera or in capturing a scene that includes moving objects.

There is also known in the art an electronic imaging system described in U.S. Pat. No. 4,823,186 by Akira Muramatsu that includes two sensors, wherein each of the sensors includes a two-dimensional array of pixels but one sensor has no color filters and the other sensor includes a pattern of color filters included with the pixels, and with an optical beam splitter to provide each image sensor with the image. Since the color sensor has a pattern of color filters applied, each pixel in the color sensor provides only a single color. When an image is captured with this system, each point in the electronic image includes a luminance value and one color value, and the color image must have the missing colors at each pixel location interpolated from the nearby colors. Although this system improves the light sensitivity over a single conventional image sensor, the overall complexity, size, and cost of the system is greater due to the need for two sensors and a beam splitter. Furthermore, the beam splitter directs only half the light from the image to each sensor, limiting the improvement in photographic speed.

In addition to the linear image sensor mentioned above, there are known in the art, image sensors with two-dimensional arrays of pixels where the pixels include pixels that do not have color filters applied to them. For example, see Sato, et al. in U.S. Pat. No. 4,390,895, Yamagami, et al. in U.S. Pat. No. 5,323,233, Gindele, et al. in U.S. Pat. No. 6,476,865, and Frame in U.S. Patent Application 2003/0210332. In each of the cited patents, the sampling arrangements for the color pixels versus the luminance or unfiltered pixels favor the luminance image over the color image or vice-versa or in some other way provide a suboptimal arrangement of color and luminance pixels.

Therefore, there persists a need for improving the light sensitivity for electronic capture devices that employ a single sensor with a two-dimensional array of pixels.

### SUMMARY OF THE INVENTION

The present invention is directed to providing an image sensor having a two-dimensional array of color and panchromatic pixels that provides high sensitivity and is effective in producing full color images.

Briefly summarized, according to one aspect of the present invention, the invention provides an image sensor for capturing a color image, comprising a two-dimensional array of pixels having a plurality of minimal repeating units wherein each repeating unit is composed of eight pixels having four panchromatic pixels, two pixels having the same color response, and two pixels having different color responses that are different than the pixels having the same color response, with the minimal repeating units tiled to cause each row or each column of the image sensor to have color pixels of a single color.

Another aspect of the present invention is an image sensor for capturing a color image, comprising a two-dimensional array of pixels having a plurality of minimal repeating units wherein each repeating unit is composed of eight pixels having four panchromatic pixels, two pixels having the same color response, and two pixels having different color responses that are different than the pixels having the same color response, with the minimal repeating units tiled to cause each row and each column of the image sensor to have color pixels of only two colors.

Image sensors in accordance with the present invention are particularly suitable for low-level lighting conditions, where such low level lighting conditions are the result of low scene lighting, short exposure time, small aperture, or other restriction on light reaching the sensor. They have a broad application and numerous types of image capture devices can effectively use these sensors. Additionally, image sensors in accordance with the present invention facilitate processing of the captured image to produce a final, fully color-rendered image.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a block diagram of a conventional digital still camera system that can employ a conventional sensor and processing methods or the sensor and processing methods of the current invention;

FIG. 2 (prior art) is a conventional Bayer color filter array pattern showing a minimal repeating unit and a non-minimal repeating unit;

FIG. 3 provides representative spectral quantum efficiency curves for red, green, and blue pixels, as well as a wider spectrum panchromatic quantum efficiency, all multiplied by the transmission characteristics of an infrared cut filter;

FIG. 4 (prior art) is a minimal repeating unit of a color filter array pattern with both panchromatic and color pixels;

FIGS. 5A-5B show minimal repeating units for variations of color filter array patterns of the present invention;

FIGS. 6A-6B show two ways to tile the minimal repeating unit of FIG. 5A;

FIGS. 7A-7B show minimal repeating units of the present invention that include panchromatic pixels with two sensitivities; and

FIGS. 8A-8C show the minimal repeating unit of FIG. 5A and the tiling arrangements of FIGS. 6A-6B rotated forty-five degrees;

### DETAILED DESCRIPTION OF THE INVENTION

Because digital cameras employing imaging devices and related circuitry for signal capture and correction and for exposure control are well known, the present description will be directed in particular to elements forming part of, or cooperating more directly with, method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein, that is useful for implementation of the invention is conventional and within the ordinary skill in such arts.

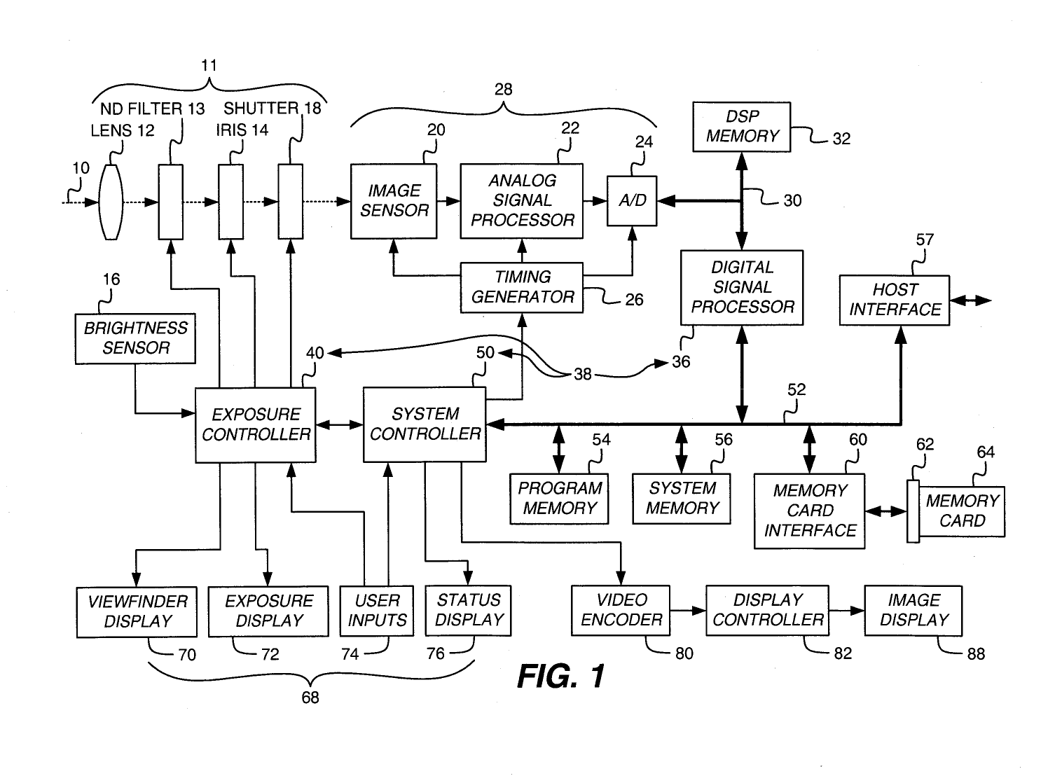

Turning now to FIG. 1, a block diagram of an image capture device shown as a digital camera embodying the present invention is shown. Although a digital camera will now be explained, the present invention is clearly applicable to other types of image capture devices. In the disclosed camera, light 10 from the subject scene is input to an imaging stage 11, where the light is focused by lens 12 to form an image on solid-state image sensor 20. Image sensor 20 converts the incident light to an electrical signal for each picture element (pixel). The image sensor 20 of the preferred embodiment is a charge coupled device (CCD) type or an active pixel sensor (APS) type (APS devices are often referred to as CMOS sensors because of the ability to fabricate them in a Complementary Metal Oxide Semiconductor Process). Other types of image sensors having two-dimensional array of pixels are used if they employ the patterns of the present invention. The present invention also makes use of an image sensor 20 having a two-dimensional array of color and panchromatic pixels as will become clear later in this specification after FIG. 1 is described. Examples of the patterns of color and panchromatic pixels of the present invention that are used with the image sensor 20 are seen in FIGS. 5A-5B, FIGS. 6A-6B, FIGS. 7A-7B, and FIGS. 8A-8C, although other patterns are used within the spirit of the present invention.

An iris block 14 that varies the aperture and the neutral density (ND) filter block 13 that includes one or more ND filters interposed in the optical path regulates the amount of light reaching the sensor 20. Also regulating the overall light level is the time that the shutter block 18 is open. The amount of light that reaches the sensor 20 is also regulated with the time that the shutter block 18 is open. The exposure controller block 40 responds to the amount of light available in the scene as metered by the brightness sensor block 16 and controls all three of these regulating functions.

This description of a particular camera configuration will be familiar to one skilled in the art, and it will be obvious that many variations and additional features are present. For example, an autofocus system is added, or the lenses are detachable and interchangeable. It will be understood that the present invention is applied to any type of digital camera, where similar functionality is provided by alternative components. For example, the digital camera is a relatively simple point and shoot digital camera, where the shutter 18 is a relatively simple movable blade shutter, or the like, instead of the more complicated focal plane arrangement. The present invention can also be practiced on imaging components included in non-camera devices such as mobile phones and automotive vehicles.

The analog signal from image sensor 20 is processed by analog signal processor 22 and applied to analog to digital (A/D) converter 24. Timing generator 26 produces various clocking signals to select rows and pixels and synchronizes the operation of analog signal processor 22 and A/D converter 24. The image sensor stage 28 includes the image sensor 20, the analog signal processor 22, the A/D converter 24, and the timing generator 26. The components of image sensor stage 28 are separately fabricated integrated circuits, or they are fabricated as a single integrated circuit as is commonly done with CMOS image sensors. The resulting stream of digital pixel values from A/D converter 24 is stored in memory 32 associated with digital signal processor (DSP) 36.

Digital signal processor 36 is one of three processors or controllers in this embodiment, in addition to system controller 50 and exposure controller 40. Although this partitioning of camera functional control among multiple controllers and processors is typical, these controllers or processors are combined in various ways without affecting the functional operation of the camera and the application of the present invention. These controllers or processors can comprise one or more digital signal processor devices, microcontrollers, programmable logic devices, or other digital logic circuits. Although a combination of such controllers or processors has been described, it should be apparent that one controller or processor is designated to perform all of the needed functions. All of these variations can perform the same function and fall within the scope of this invention, and the term “processing stage” will be used as needed to encompass all of this functionality within one phrase, for example, as in processing stage 38 in FIG. 1.

In the illustrated embodiment, DSP 36 manipulates the digital image data in its memory 32 according to a software program permanently stored in program memory 54 and copied to memory 32 for execution during image capture. DSP 36 executes the software necessary for practicing image processing shown in FIG. 1. Memory 32 includes of any type of random access memory, such as SDRAM. A bus 30 comprising a pathway for address and data signals connects DSP 36 to its related memory 32, A/D converter 24 and other related devices.

System controller 50 controls the overall operation of the camera based on a software program stored in program memory 54, which can include Flash EEPROM or other nonvolatile memory. This memory can also be used to store image sensor calibration data, user setting selections and other data which must be preserved when the camera is turned off. System controller 50 controls the sequence of image capture by directing exposure controller 40 to operate the lens 12, ND filter 13, iris 14, and shutter 18 as previously described, directing the timing generator 26 to operate the image sensor 20 and associated elements, and directing DSP 36 to process the captured image data. After an image is captured and processed, the final image file stored in memory 32 is transferred to a host computer via host interface 57, stored on a removable memory card 64 or other storage device, and displayed for the user on image display 88.

A bus 52 includes a pathway for address, data and control signals, and connects system controller 50 to DSP 36, program memory 54, system memory 56, host interface 57, memory card interface 60 and other related devices. Host interface 57 provides a high-speed connection to a personal computer (PC) or other host computer for transfer of image data for display, storage, manipulation or printing. This interface is an IEEE1394 or USB2.0 serial interface or any other suitable digital interface. Memory card 64 is typically a Compact Flash (CF) card inserted into socket 62 and connected to the system controller 50 via memory card interface 60. Other types of storage that are used include without limitation PC-Cards, MultiMedia Cards (MMC), or Secure Digital (SD) cards.

Processed images are copied to a display buffer in system memory 56 and continuously read out via video encoder 80 to produce a video signal. This signal is output directly from the camera for display on an external monitor, or processed by display controller 82 and presented on image display 88. This display is typically an active matrix color liquid crystal display (LCD), although other types of displays are used as well.

A user control and interface status 68, includes all or any combination of viewfinder display 70, exposure display 72, status display 76 and image display 88, and user inputs 74, is controlled by a combination of software programs executed on exposure controller 40 and system controller 50. User inputs 74 typically include some combination of buttons, rocker switches, joysticks, rotary dials or touchscreens. Exposure controller 40 operates light metering, exposure mode, autofocus and other exposure functions. The system controller 50 manages the graphical user interface (GUI) presented on one or more of the displays, e.g., on image display 88. The GUI typically includes menus for making various option selections and review modes for examining captured images.

Exposure controller 40 accepts user inputs selecting exposure mode, lens aperture, exposure time (shutter speed), and exposure index or ISO speed rating and directs the lens and shutter accordingly for subsequent captures. Brightness sensor 16 is employed to measure the brightness of the scene and provide an exposure meter function for the user to refer to when manually setting the ISO speed rating, aperture and shutter speed. In this case, as the user changes one or more settings, the light meter indicator presented on viewfinder display 70 tells the user to what degree the image will be over or underexposed. In an automatic exposure mode, the user changes one setting and the exposure controller 40 automatically alters another setting to maintain correct exposure, e.g., for a given ISO speed rating when the user reduces the lens aperture the exposure controller 40 automatically increases the exposure time to maintain the same overall exposure.

The ISO speed rating is an important attribute of a digital still camera. The exposure time, the lens aperture, the lens transmittance, the level and spectral distribution of the scene illumination, and the scene reflectance determine the exposure level of a digital still camera. When an image from a digital still camera is obtained using an insufficient exposure, proper tone reproduction can generally be maintained by increasing the electronic or digital gain, but the image will contain an unacceptable amount of noise. As the exposure is increased, the gain is decreased, and therefore the image noise can normally be reduced to an acceptable level. If the exposure is increased excessively, the resulting signal in bright areas of the image can exceed the maximum signal level capacity of the image sensor or camera signal processing. This can cause image highlights to be clipped to form a uniformly bright area, or to bloom into surrounding areas of the image. It is important to guide the user in setting proper exposures. An ISO speed rating is intended to serve as such a guide. In order to be easily understood by photographers, the ISO speed rating for a digital still camera should directly relate to the ISO speed rating for photographic film cameras. For example, if a digital still camera has an ISO speed rating of ISO 200, then the same exposure time and aperture should be appropriate for an ISO 200 rated film/process system.

The ISO speed ratings are intended to harmonize with film ISO speed ratings. However, there are differences between electronic and film-based imaging systems that preclude exact equivalency. Digital still cameras can include variable gain, and can provide digital processing after the image data has been captured, enabling tone reproduction to be achieved over a range of camera exposures. It is therefore possible for digital still cameras to have a range of speed ratings. This range is defined as the ISO speed latitude. To prevent confusion, a single value is designated as the inherent ISO speed rating, with the ISO speed latitude upper and lower limits indicating the speed range, that is, a range including effective speed ratings that differ from the inherent ISO speed rating. With this in mind, the inherent ISO speed is a numerical value calculated from the exposure provided at the focal plane of a digital still camera to produce specified camera output signal characteristics. The inherent speed is usually the exposure index value that produces peak image quality for a given camera system for normal scenes, where the exposure index is a numerical value that is inversely proportional to the exposure provided to the image sensor.

The foregoing description of a digital camera will be familiar to one skilled in the art. It will be obvious that there are many variations of this embodiment that are possible and is selected to reduce the cost, add features or improve the performance of the camera. The following description will disclose in detail the operation of this camera for capturing images according to the present invention. Although this description is with reference to a digital camera, it will be understood that the present invention applies for use with any type of image capture device having an image sensor with color and panchromatic pixels.

The image sensor 20 shown in FIG. 1 typically includes a two-dimensional array of light sensitive pixels fabricated on a silicon substrate that provide a way of converting incoming light at each pixel into an electrical signal that is measured. As the sensor is exposed to light, free electrons are generated and captured within the electronic structure at each pixel. Capturing these free electrons for some period of time and then measuring the number of electrons captured or measuring the rate at which free electrons are generated measures the light level at each pixel. In the former case, accumulated charge is shifted out of the array of pixels to a charge to voltage measurement circuit as in a charge coupled device (CCD), or the area close to each pixel contains elements of a charge to voltage measurement circuit as in an active pixel sensor (APS or CMOS sensor).

Whenever general reference is made to an image sensor in the following description, it is understood to be representative of the image sensor 20 from FIG. 1. It is further understood that all examples and their equivalents of image sensor architectures and pixel patterns of the present invention disclosed in this specification is used for image sensor 20.

In the context of an image sensor, a pixel (a contraction of “picture element”) refers to a discrete light sensing area and charge shifting or charge measurement circuitry associated with the light sensing area. In the context of a digital color image, the term pixel commonly refers to a particular location in the image having associated color values.

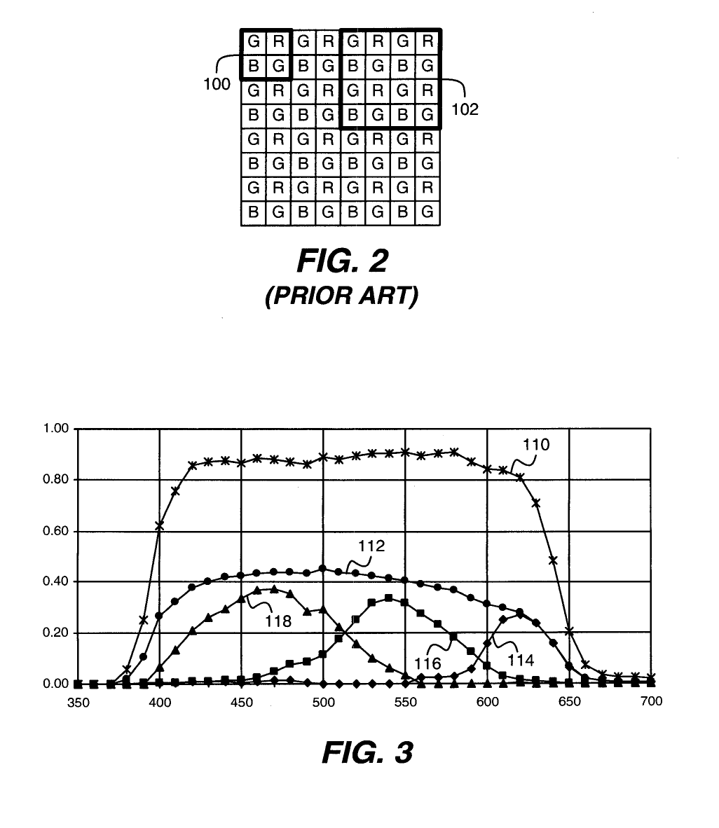

In order to produce a color image, the array of pixels in an image sensor typically has a pattern of color filters placed over them. FIG. 2 shows a pattern of red, green, and blue color filters that is commonly used. This particular pattern is commonly known as a Bayer color filter array (CFA) after its inventor Bryce Bayer as disclosed in U.S. Pat. No. 3,971,065. This pattern is effectively used in image sensors having a two-dimensional array of color pixels. As a result, each pixel has a particular color photoresponse that, in this case, is a predominant sensitivity to red, green or blue light. Another useful variety of color photoresponses is a predominant sensitivity to magenta, yellow, or cyan light. In each case, the particular color photoresponse has high sensitivity to certain portions of the visible spectrum, while simultaneously having low sensitivity to other portions of the visible spectrum. The term color pixel will refer to a pixel having a color photoresponse.

The set of color photoresponses selected for use in a sensor usually has three colors, as shown in the Bayer CFA, but it can also include four or more. As used herein, a panchromatic photoresponse refers to a photoresponse having a wider spectral sensitivity than those spectral sensitivities represented in the selected set of color photoresponses. A panchromatic photosensitivity can have high sensitivity across the entire visible spectrum. The term panchromatic pixel will refer to a pixel having a panchromatic photoresponse. Although the panchromatic pixels generally have a wider spectral sensitivity than the set of color photoresponses, each panchromatic pixel can have an associated filter. Such filter is either a neutral density filter or a color filter.

When a pattern of color and panchromatic pixels is on the face of an image sensor, each such pattern has a repeating unit that is a contiguous subarray of pixels that acts as a basic building block. By juxtaposing multiple copies of the repeating unit, the entire sensor pattern is produced. The juxtaposition of the multiple copies of repeating units is done in diagonal directions as well as in the horizontal and vertical directions.

A minimal repeating unit is a repeating unit such that no other repeating unit has fewer pixels. For example, the CFA in FIG. 2 includes a minimal repeating unit that is two pixels by two pixels as shown by pixel block 100 in FIG. 2. Multiple copies of this minimal repeating unit are tiled to cover the entire array of pixels in an image sensor. The minimal repeating unit is shown with a green pixel in the upper right corner, but three alternative minimal repeating units can easily be discerned by moving the heavy outlined area one pixel to the right, one pixel down, or one pixel diagonally to the right and down. Although pixel block 102 is a repeating unit, it is not a minimal repeating unit because pixel block 100 is a repeating unit and block 100 has fewer pixels than block 102.

An image captured using an image sensor having a two-dimensional array with the CFA of FIG. 2 has only one color value at each pixel. In order to produce a full color image, there are a number of techniques for inferring or interpolating the missing colors at each pixel. These CFA interpolation techniques are well known in the art and reference is made to the following patents: U.S. Pat. No. 5,506,619, U.S. Pat. No. 5,629,734, and U.S. Pat. No. 5,652,621.

FIG. 3 shows the relative spectral sensitivities of the pixels with red, green, and blue color filters in a typical camera application. The X-axis in FIG. 3 represents light wavelength in nanometers, and the Y-axis represents efficiency. In FIG. 3, curve 110 represents the spectral transmission characteristic of a typical filter used to block infrared and ultraviolet light from reaching the image sensor. Such a filter is needed because the color filters used for image sensors typically do not block infrared light, hence the pixels are unable to distinguish between infrared light and light that is within the passbands of their associated color filters. The infrared blocking characteristic shown by curve 110 prevents infrared light from corrupting the visible light signal. The spectral quantum efficiency, i.e. the proportion of incident photons that are captured and converted into a measurable electrical signal, for a typical silicon sensor with red, green, and blue filters applied is multiplied by the spectral transmission characteristic of the infrared blocking filter represented by curve 110 to produce the combined system quantum efficiencies represented by curve 114 for red, curve 116 for green, and curve 118 for blue. It is understood from these curves that each color photoresponse is sensitive to only a portion of the visible spectrum. By contrast, the photoresponse of the same silicon sensor that does not have color filters applied (but including the infrared blocking filter characteristic) is shown by curve 112; this is an example of a panchromatic photoresponse. By comparing the color photoresponse curves 114, 116, and 118 to the panchromatic photoresponse curve 112, it is clear that the panchromatic photoresponse is three to four times more sensitive to wide spectrum light than any of the color photoresponses. Although another sensor of a different type may have different photoresponses than shown by FIG. 3, it is clear that the broader panchromatic response will always be more sensitive to wide spectrum light than any of the color photoresponses.

The greater panchromatic sensitivity shown in FIG. 3 permits improving the overall sensitivity of an image sensor by intermixing pixels that include color filters with pixels that do not include color filters. However, the color filter pixels will be significantly less sensitive than the panchromatic pixels. In this situation, if the panchromatic pixels are properly exposed to light such that the range of light intensities from a scene cover the full measurement range of the panchromatic pixels, then the color pixels will be significantly underexposed. Hence, it is advantageous to adjust the sensitivity of the color filter pixels so that they have roughly the same sensitivity as the panchromatic pixels. The sensitivity of the color pixels is increased, for example, by increasing the size of the color pixels relative to the panchromatic pixels, with an associated reduction in spatial pixels.

In an image capture device that includes panchromatic pixels as well as color pixels, the arrangement of panchromatic and color pixels within the pixel array affects the spatial sampling characteristics of the image capture device. To the extent that panchromatic pixels take the place of color pixels, the frequency of color sampling is reduced. For example, if one of the green pixels in minimal repeating unit 100 in FIG. 2 is replaced with a panchromatic pixel, as in Gindele, et al. in U.S. Pat. No. 6,476,865, then the green sampling frequency is reduced because there are half as many green pixels as in the original pattern shown in FIG. 2. In this particular case, the sampling frequencies of the panchromatic pixels and each of the color pixels are the same.

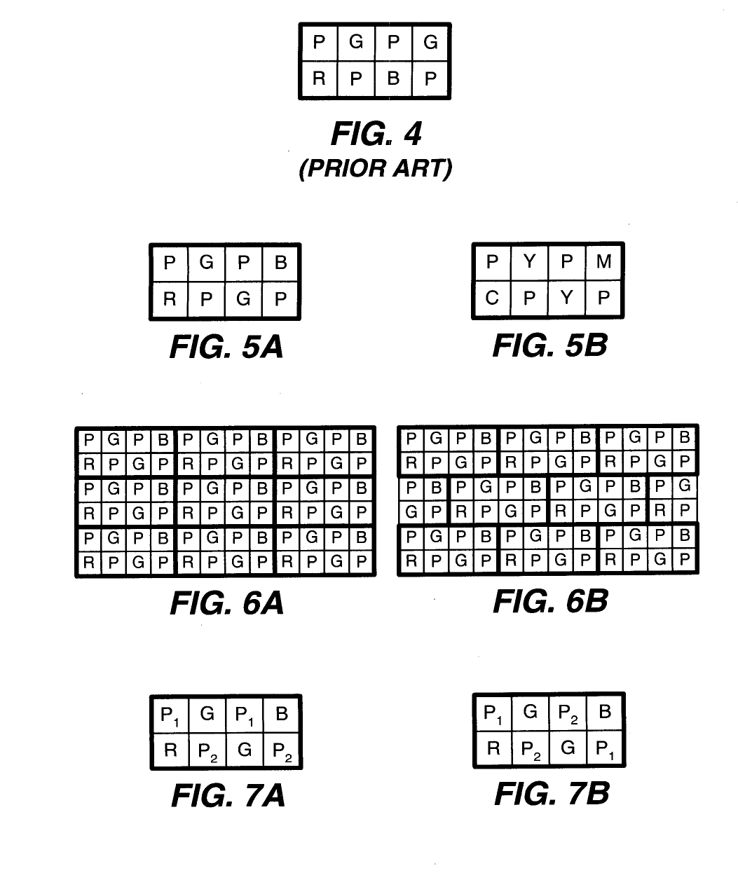

Since the panchromatic pixels are generally more sensitive than the color pixels, it is desirable to have higher sampling frequency for the panchromatic pixels than any one of the color pixels, thereby to provide a robust, higher sensitivity panchromatic representation of the image to provide the basis for subsequent image processing and interpolation of missing colors at each pixel. For example, Yamagami, et al. in U.S. Pat. No. 5,323,233 shows a pattern with 50% panchromatic pixels, 25% green pixels, and 12.5% each of red and blue pixels. A minimal repeating unit of this pattern is shown in FIG. 4. Having twice as many green pixels as either of the color pixels is consistent with the widely used Bayer pattern, but it does not necessarily provide an advantage when combined with a robust panchromatic sampling arrangement as shown in Yamagami. Reducing the green sampling arrangement to be comparable to the other colors will not have a significant adverse affect on the fully processed image.

FIG. 5A shows a minimal repeating unit of the present invention with four panchromatic pixels uniformly disposed throughout the minimal repeating unit, and one red pixel (R), two green pixels (G), and one blue pixel.

FIG. 5B shows another minimal repeating unit of the present invention. FIG. 5B is similar to FIG. 5A except red, green, and blue pixels have been replaced with cyan, yellow, and magenta pixels, respectively, demonstrating that the present invention can be used with any set of four distinct spectral sensitivities.

The minimal repeating unit of FIG. 5A is tiled to provide a larger array of pixels with no missing pixels in several ways. FIG. 6A shows a tiling arrangement in which the minimal repeating unit of FIG. 5A is tiled evenly in rows and columns. FIG. 6B shows a tiling arrangement in which every row of minimal repeating units is shifted right by two pixels with respect to the row above; in other words, the minimal repeating unit of FIG. 5B is tiled evenly in rows, with each row shifted right one-half of the minimal repeating unit width with respect to the adjacent row above.

The tiling arrangement for FIG. 5A shown in FIG. 6A provides a pixel array with each column having panchromatic pixels and color pixels of a single color. Rotating the arrangement of FIG. 6A by 90 degrees provides an alternative pixel array of the present invention. In this rotated case, each row of the pixel array has panchromatic pixels and color pixels of a single color.

The tiling arrangement for FIG. 5A shown in FIG. 6B provides a pixel array with each column and each row having panchromatic pixels and color pixels of two colors. Rotating the arrangement of FIG. 6B by 90 degrees provides an alternative pixel array of the present invention. In this rotated case, each row and each column of the pixel array has panchromatic pixels and color pixels of two colors.

The tiling arrangements of FIGS. 6A and 6B are two embodiments of the present invention. Note that both tiling arrangements provide a panchromatic checkerboard of pixels with each panchromatic pixel diagonally adjacent to four other panchromatic pixels. Note further that the two arrangements of color pixels provide differing color sampling characteristics. For example, the color sampling of FIG. 6A has higher vertical frequency than horizontal frequency. Alternatively, the color sampling of FIG. 6B has equal vertical frequency and horizontal frequency. The differing color sampling frequencies of FIG. 6A are useful when the pixels are rectangular and tall and narrow; the equal color sampling frequencies of FIG. 6B are useful when the pixels are square.

Generalizing, the image sensor in accordance with the present invention can have the following minimal repeating unit:

| | | | |
|---|---|---|---|
| P | B | P | C |
| A | P | B | P |

wherein P represents panchromatic pixels and A, B, and C represent pixels with different color responses. In one arrangement, A, B, and C represent pixels with color responses individually selected from red, green, or blue color responses. In a specific arrangement, A represents pixels with red color response, B represents pixels with green color response, and C represents pixels with blue color response. Alternatively, A, B, and C can represent pixels with color responses individually selected from cyan, magenta, or yellow responses. In a specific arrangement, A represents pixels with cyan color response, B represents pixels with yellow color response, and C represents pixels with magenta color response.

The panchromatic pixels in patterns of the present invention do not need to be identical in sensitivity. For example, FIG. 7A shows a minimal repeating unit similar to FIG. 5A in which the two of the panchromatic pixels are replaced with panchromatic pixels of a different photographic speed than the original panchromatic pixels. Panchromatic pixels with different photographic sensitivities are used to capture a broader range of light levels. FIG. 7B shows another minimal repeating unit with an alternative arrangement of panchromatic pixels with two different photographic speeds.

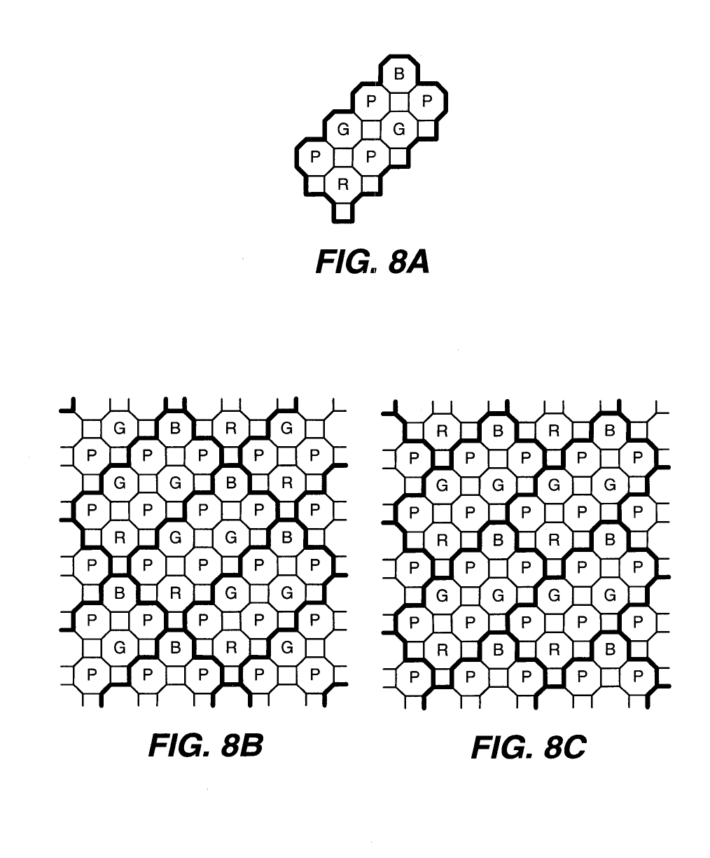

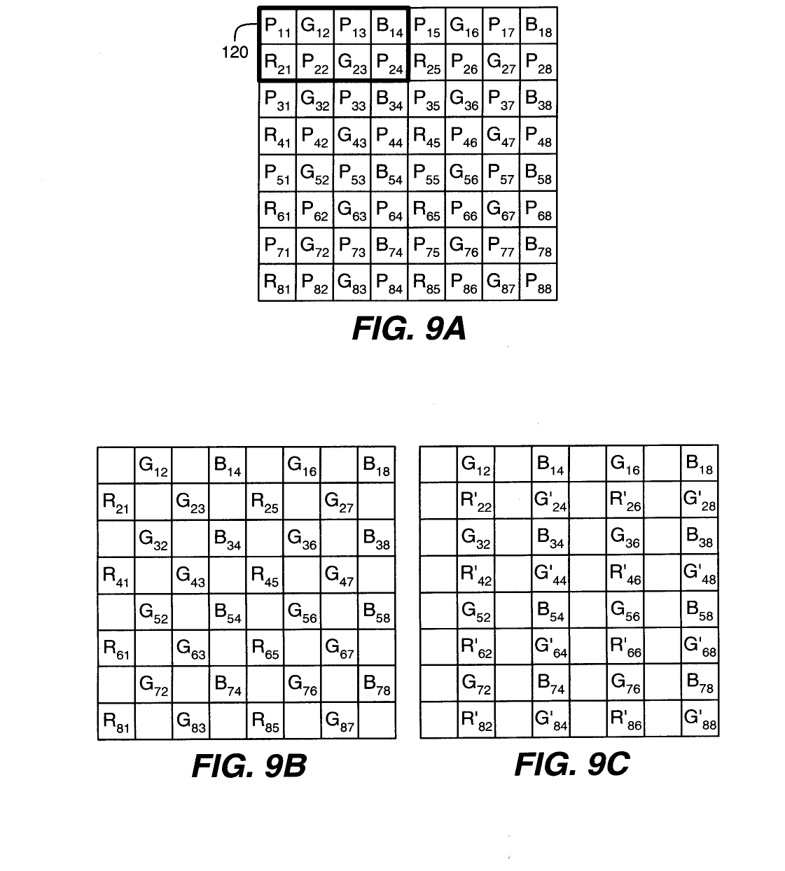

Note that rotating any of the arrays of FIG. 5A, FIG. 7A, FIG. 7B, or any of the other previously described embodiments of the present invention is completely within the scope of the present invention. For example, FIG. 8A shows a minimal repeating unit of an arrangement of octagonal pixels that is equivalent to rotating the minimal repeating unit of FIG. 5A forty-five degrees counter-clockwise. FIG. 8B shows the minimal repeating unit of FIG. 8A tiled to form a pattern that is equivalent to a forty-five degree counter-clockwise rotation of FIG. 6A. FIG. 8C shows the minimal repeating unit of FIG. 8A tiled to form a pattern that is equivalent to a forty-five degree counter-clockwise rotation of FIG. 6B. In the case of these rotated arrangements, and in a manner consistent with the rotation of the minimal repeating units and tiling arrangements, rows and columns of pixels are considered rotated.

For some purposes it is advantageous to produce a lower resolution image from the sensor, for example to provide a higher frame rate for video capture or to provide an active preview image on a display screen. In FIG. 1, DSP 36 provides a processed image from the raw image provided by the sensor and imaging subsystem. In order to provide a series of processed images at video frame rates, DSP 36 in many cases provides a hardwired image-processing path (as opposed to a programmable image processing path). Such hardwired image processing paths often require sensor data to conform to the Bayer filter pattern of FIG. 2. Therefore, it is advantageous to provide the ability to read conveniently a reduced resolution, Bayer image from a sensor of the present invention.

Referring to FIG. 9A, there is shown an arrangement of color and panchromatic pixels of the present invention. FIG. 9A is similar to FIG. 6B, with the addition of indices to each pixel to help demonstrate the production of a reduced resolution Bayer image from an image sensor of the present invention. In FIG. 9A, the minimal repeating unit 120 is shown to be the same as that shown in FIG. 5A. FIG. 9B shows an arrangement of pixels that includes only the color pixels from FIG. 9A. This is close to a Bayer arrangement, except odd and even rows of pixels are offset horizontally. The reduced resolution Bayer arrangement of FIG. 9C is produced from the color pixels of FIG. 9B as follows. The blue pixels in FIG. 9B (B₁₄, B₁₈, B₃₄, B₃₈, B₅₄, B₅₈, B₇₄, B₇₈) and the green pixels in FIG. 9B that are on the same row as the aforementioned blue pixels (G₁₂, G₁₆, G₃₂, G₃₆, G₅₂, G₅₆, G₇₂, G₇₆) are used in FIG. 9C without modification. The remaining green pixels (G′₂₄, G′₂₈, G′₄₄, G′₄₈, G′₈₄, G′₈₈) and the red pixels (R′₂₂, R′₂₆, R′₄₂, R′₄₆, R′₆₂, R′₆₆, R′₈₂, R′₈₆) in FIG. 9C are interpolated from green and red pixels in corresponding rows of FIG. 9B. An example interpolation for R′₂₂ is given: R′₂₂=(3*R₂₁+1*R₂₅)/4. Other forms of interpolation that are well known to those skilled in the art such as bicubic interpolation and adaptive interpolation can be used. The Bayer image of FIG. 9C has ½ the horizontal resolution and the full vertical resolution of the original image of FIG. 9A. This resulting image can be decimated further for VGA (640 rows by 480 columns) output or any other size format output.

The interpolation of the pixels shown in FIG. 9B to obtain the pixels shown in FIG. 9C can be done, for example, by combining charge in the pixels, by averaging sampled voltages, or by combining digital representations of the pixel signals.

The invention has been described in detail with particular reference to certain preferred embodiments thereof, but it will be understood that variations and modifications are effected within the spirit and scope of the invention.

### PARTS LIST

10 light from subject scene
11 imaging stage
12 lens
13 neutral density filter
14 iris
16 brightness sensor
18 shutter
20 image sensor
22 analog signal processor
24 analog to digital (A/D) converter
26 timing generator
28 image sensor stage
30 digital signal processor (DSP) bus
32 digital signal processor (DSP) memory
36 digital signal processor (DSP)
38 processing stage
40 exposure controller
50 system controller
52 system controller bus
54 program memory
56 system memory
57 host interface
60 memory card interface
62 memory card socket
64 memory card
68 user control and status interface
70 viewfinder display
72 exposure display
74 user inputs
76 status display
80 video encoder
82 display controller
88 image display
100 minimal repeating unit for Bayer pattern
102 repeating unit for Bayer pattern that is not minimal
110 spectral transmission curve of infrared blocking filter
112 unfiltered spectral photoresponse curve of sensor
114 red photoresponse curve of sensor
116 green photoresponse curve of sensor
118 blue photoresponse curve of sensor
120 minimal repeating unit of the present invention

1. An image sensor for capturing a color image, comprising a two-dimensional array of pixels having a plurality of minimal repeating units wherein each repeating unit is composed of eight pixels having four panchromatic pixels, two pixels having the same color response, and two pixels having different color responses that are different than the pixels having the same color response, with the minimal repeating units tiled to cause each row or each column of the array of pixels to have color pixels of a single color.

2. The image sensor of claim 1 wherein the panchromatic pixels are in a checkerboard pattern.

3. The image sensor of claim 1 having the following minimal repeating unit:

| | | | |
|---|---|---|---|
| P | B | P | C |
| A | P | B | P |

wherein P represents panchromatic pixels and A, B, and C represent pixels with different color responses.

4. The image sensor of claim 3 wherein A, B, and C represent pixels with color responses individually selected from red, green, or blue color responses.

5. The image sensor of claim 3 wherein A represents pixels with red color response, B represents pixels with green color response, and C represents pixels with blue color response.

6. The image sensor of claim 3 wherein A, B, and C represent pixels with color responses individually selected from cyan, magenta, or yellow responses.

7. The image sensor of claim 3 wherein A represents pixels with cyan color response, B represents pixels with yellow color response, and C represents pixels with magenta color response.

8. An image sensor for capturing a color image, comprising a two-dimensional array of pixels having a plurality of minimal repeating units wherein each repeating unit is composed of eight pixels having four panchromatic pixels, two pixels having the same color response, and two pixels having different color responses that are different than the pixels having the same color response, with the minimal repeating units tiled to cause each row and each column of the array of pixels to have color pixels of only two colors.

9. The image sensor of claim 8 wherein the panchromatic pixels are in a checkerboard pattern.

10. The image sensor of claim 8 having the following minimal repeating unit:

| | | | |
|---|---|---|---|
| P | B | P | C |
| A | P | B | P |

wherein P represents panchromatic pixels and A, B, and C represent pixels with different color responses.

11. The image sensor of claim 10 wherein A, B, and C represent pixels with color responses individually selected from red, green, or blue color responses.

12. The image sensor of claim 10 wherein A represents pixels with red color response, B represents pixels with green color response, and C represents pixels with blue color response.

13. The image sensor of claim 10 wherein A, B, and C represent pixels with color responses individually selected from cyan, magenta, or yellow responses.

14. The image sensor of claim 10 wherein A represents pixels with cyan color response, B represents pixels with yellow color response, and C represents pixels with magenta color response.
